(19) United States
(12) Patent Application Publication
(10) Pub. No.: US 2019/0113661 A1
(43) Pub. Date: Apr. 18, 2019

(54) LIQUID LENS WITH A TUNABLE FOCUS, AND METHOD OF FABRICATION OF SAME

(71) Applicants: Alidad AMIRFAZLI, Toronto (CA); Huanchen CHEN, Toronto (CA); Nima TABATABAEI, Toronto (CA)

(72) Inventors: Alidad AMIRFAZLI, Toronto (CA); Huanchen CHEN, Toronto (CA); Nima TABATABAEI, Toronto (CA)

(21) Appl. No.: 15/784,063

(22) Filed: Oct. 13, 2017

(51) Int. Cl. G02B 3/14; G02B 7/04

(52) U.S. Cl. CPC G02B 3/14; G02B 7/04

(57) ABSTRACT

A variable focus lens comprising: at least two substrates having a gap defined therebetween; a fluid material disposed between the at least two substrates to form a fluid bridge with a fluid bridge interface, the fluid material having a predetermined volume; and wherein at least one of a magnitude of the gap, the predetermined volume, curvature of the at least two substrates, wettability of the at least two substrates, and electrical stress state on the fluid bridge interface determines a working distance of the lens.

### CROSS-REFERENCE TO RELATED APPLICATIONS

This application claims the benefit of priority to U.S. Provisional Application Ser. No. 62/407,847, filed on Oct. 13, 2016.

### FIELD OF INVENTION

The present invention relates generally to the field of optical lenses, and more particularly, to lenses with a tunable focus.

### BACKGROUND

Most optical systems used in machine vision and image processing systems are based on glass or plastic lenses, and these systems employ either fixed focal length lenses, or variable focal length lenses. Generally, in most mechanically-based lens systems, variable focal length lenses are achieved by translating a plurality of optical elements relative to each other, or using multiple lenses. An alternative approach for achieving lenses with variable focal length is the use of liquid-based lenses, such as liquid-crystal (LC)-based cylindrical lenses, for which several methods have been proposed. These variable-focal-length liquid lenses have the advantages of adaptable corrections, small size, lens power, simplicity in structure, and/or low cost, when compared to glass or plastic lenses. As a result, such liquid lenses have the potential to be miniaturized and widely used in different types of optical zoom systems, e.g., microscopy, scanners, mobile phone cameras and micro-electromechanical systems.

Existing liquid lens systems generally follow two general design approaches to provide variable focus lenses. In a first design approach, the lens focal distance is manipulated by incorporating various techniques to change the surrounding environment of the liquid fluid interface or stimuli while keeping the liquid lens volume constant, e.g., pressure variation, changing of the geometry constraints, and electrowetting. In second design approach, lens liquid is held in a chamber made out of deformable transparent membranes. The shape of the transparent membranes, hence the focal length of the lens, can be controlled by changing the volume of the liquid injected into the chamber. Cylindrical lenses, whose surfaces have at least a partially cylindrical profile, are also needed for certain applications, e.g., to focus incoming light onto a line, or to change the aspect ratio of an image. Very recently, the second general design described above has been used to create variable focus cylindrical liquid lenses, primarily for use in lens arrays. However, the lenses fabricated using these two approaches are still costly, bulky and are not readily customizable, despite having advantages over the mechanically-based systems.

It is an object of the present invention to mitigate or obviate at least one of the above-mentioned disadvantages.

### SUMMARY OF THE INVENTION

In one of its aspects, there is provided a variable focus lens comprising:

at least two substrates having a gap defined therebetween;

a fluid material disposed between the at least two substrates to form a fluid bridge with a fluid bridge interface, the fluid material having a predetermined volume; and

wherein at least one of a magnitude of the gap, the predetermined volume, curvature of the at least two substrates, wettability of the at least two substrates, and electrical stress state on the fluid bridge interface determines a working distance of the lens.

In another of its aspects, there is provided a method for fabricating a variable focus lens, the method comprising steps of:

separating a first substrate and a second substrate by a distance (H),

disposing a fluid material between the first substrate and the second substrate to form a fluid bridge with a fluid bridge interface, the fluid bridge having a predetermined volume (V) of the fluid material; and wherein at least one of the first substrate and the second substrate is moveable to change the magnitude of the distance (H);

surrounding said fluid bridge with a second fluid material other than air; and

whereby the magnitude of the distance (H) and the magnitude of the volume (V) determines at least one of the properties of the variable focus lens.

In another of its aspects, there is provided a tunable lens system comprising:

a first substrate and a second substrate separated by a variable gap;

a fluid bridge disposed between the variable gap with a fluid bridge interface, the fluid bridge comprising a variable volume; and

a controller coupled to at least one of the first substrate and the second substrate to change the magnitude of the variable gap; and

wherein a variable working distance of the lens is dependent at least one of the variable gap, the variable volume, curvature of the at least two substrates, wettability of the substrates, and electrical stress state on the fluid bridge interface.

Advantageously, the cylindrical liquid lens using a liquid bridge between two narrow surfaces is tunable as the interface of the bridge acts as a tunable-focus cylindrical liquid lens due to the surface edge effect and the wettability of the liquid. The working distance of the lens, defined as the distance between the focal points and the lens system, may be adjusted by changing the height of the bridge (H) and the volume of the liquid (V) and wettability of the substrates (θ), and the lens can serve as either a diverging or a converging lens. By varying H and/or V and/or θ, the optical characteristics of the lens can changed in a relatively short time, and in a predictable manner using a mechanical or an electrical actuating means, thereby resulting in a highly customizable, and compact lens.

### BRIEF DESCRIPTION OF THE DRAWINGS

Several exemplary embodiments of the present invention will now be described, by way of example only, with reference to the appended drawings in which:

FIGS. 1a to 1c show a profile of a liquid bridge between two identical rectangular solid surfaces for various perspectives;

FIGS. 2a and 2b illustrate a process by which a simulation finds the shape of a water bridge between two identical surfaces;

FIG. 3a is a graph showing the curvature of a liquid bridge between two identical surfaces, the curvature being a function of the height (H) of the bridge;

FIG. 3b is a graph showing the curvature of three different volume (V) liquid bridges between two identical surfaces, each bridge having height H=2 mm;

FIG. 4 is a schematic illustration of an experimental setup for testing a lens formed from a liquid bridge;

FIG. 5a is a side view image of a liquid bridge;

FIG. 5b is a cross-sectional image of a laser beam passing through the liquid bridge of FIG. 5a taken at Position 1;

FIG. 5c is a cross-sectional image of a laser beam passing through the liquid bridge of FIG. 5a taken at Position 2;

FIG. 5d is a cross-sectional image of a laser beam after passing through the liquid bridge of FIG. 5b;

FIG. 5e is an image of the corresponding identified laser beam profile after passing through the liquid bridge of FIG. 5b;

FIG. 6a is a schematic illustration of an ideal lens model constructed for simulation in Zemax® software, the lens model corresponding to the liquid bridge of FIG. 5a;

FIG. 6b is an illustration of simulation results from Zemax for the ideal lens model shown in FIG. 6a;

FIG. 7 is a graph showing values of a height varying ratio (Λ^{h}), determined both experimentally and by simulation, and a width varying ratio (Λ^{w}), determined experimentally, for the liquid bridge of FIG. 5a and the modeled liquid bridge of FIG. 6b, with the values taken at two positions and shown as a function of the height (H) of the liquid bridge;

FIG. 8a is a graph of the principal curvature (k₁^{a}) of a 160 μl liquid bridge as a function of the height (H) of the liquid bridge;

FIG. 8b is a graph of the working distance of a 160 μl liquid bridge as a function of the height (H) of the liquid bridge;

FIG. 9 is a graph of the principal curvature (k₁^{a}) for liquid bridges with six different volumes (120 μl, 140 μl, 160 μl, 180 μl, 300 μl, and 400 μl) as a function of the height (H) of each liquid bridge;

FIG. 10 shows an exemplary tunable focal length cylindrical liquid lens;

FIG. 11 shows a high level flow diagram illustrating exemplary process steps for fabricating a tunable focal length cylindrical liquid lens;

FIG. 12 shows an exemplary fixed focal cylindrical length liquid lens;

FIG. 13 shows a high level flow diagram illustrating exemplary process steps for fabricating a fixed focal length cylindrical liquid lens; and

FIG. 14 is an exemplary computing system.

### DETAILED DESCRIPTION OF EXEMPLARY EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Described herein is a technique to create a tunable focal cylindrical liquid lens by forming a liquid bridge between two narrow surfaces. The focal length of such lens can be manipulated by either adjusting the surrounding environment including wettability or the volume of the liquid, essentially creating a new and novel design approach that is distinct from the first and second designs approaches described above.

Due to surface edge effects, the contact line of a liquid droplet can be pinned once it reaches the edge of a solid surface. Pinning of the contact line on the edge has been shown to allow for formation of a cylindrical interface between two parallel surfaces having a large aspect ratio. As such, forming a liquid bridge between two long and narrow surfaces can be used to make a cylindrical liquid lens. By adjusting the substrate wettability also the said effect may be achieved.

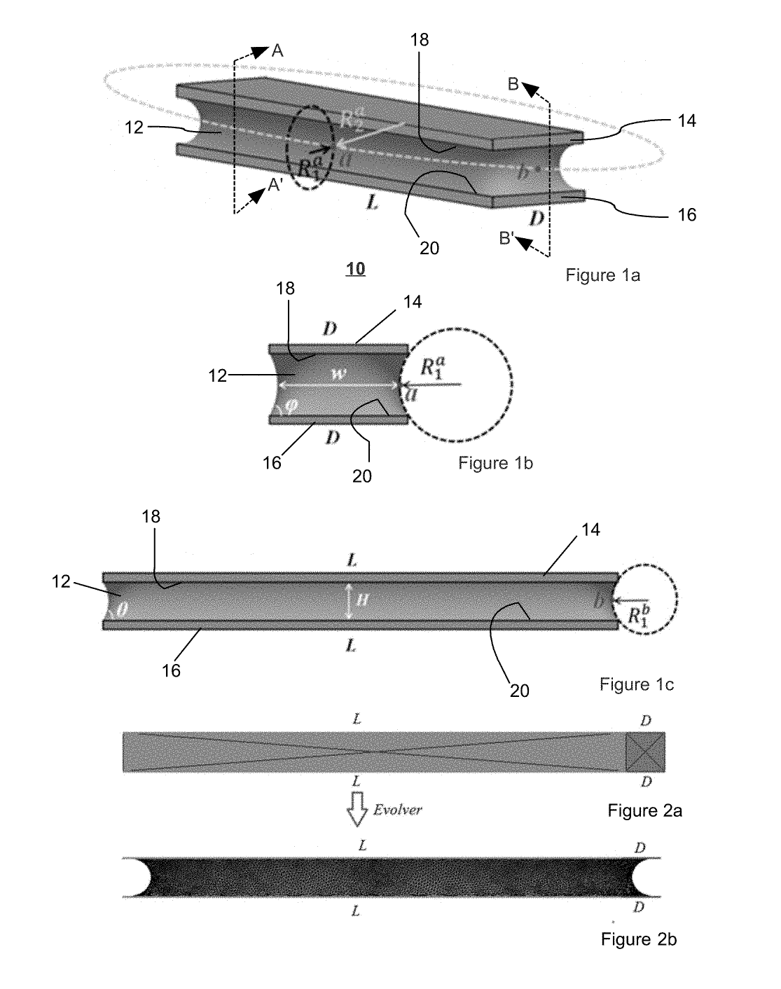

FIGS. 1a, 1b and 1c show an exemplary simulated tunable focal cylindrical liquid lens 10 formed by having a fluid bridge 12 sandwiched between two opposed surfaces 14, 16 of substrates 18, 20, respectively. FIG. 1a shows a perspective view of tunable focal cylindrical liquid lens 10, while FIG. 1b shows a transverse sectional view taken along line A-A′, and FIG. 1c shows a longitudinal sectional view taken along line B-B′. Simulated tunable focal cylindrical liquid lens 10 is achieved using Surface Evolver (SE) application software program from Susquehanna University, Selinsgrove, Pa., U.S.A., commonly used for the study of liquid interface shape under varies constraints, and for finding the equilibrium interface geometry by minimizing the surface energy subjected to constraints. Other suitable application software programs may be used for simulations. Exemplary process steps for simulating tunable focal cylindrical liquid lens 10 will now be described. Two substrates 18, 20 with opposed surfaces 14, 16 are selected, and each of two substrates 18, 20 are assigned a length (L) and depth (D) and wettability. Next, a cuboid of fluid such as water, is selected for placement between opposed surfaces 14, 16. A friction model based is then applied and the contact lines of bridge 12 are pinned during the entire Evolver process. In one example, bridge 12 comprises a volume of 200 μl water, and two opposed surfaces 14, 16 dimensioned with L=30 mm and D=4 mm and a distance between opposed surfaces 14, 16 surfaces, or height (H) of 2 mm. FIGS. 2a and 2b illustrate the process of an exemplary simulation for finding the shape of an exemplary bridge 12 between two identical surfaces 14, 16. The substrates 18, 20 may comprise flat, planar, or curved surfaces 14, 16.

Next, the cylindrical interface in liquid bridge 12 between opposed surfaces 14, 16 is changed by, for example, changing the distance (H) between opposed surfaces 14, 16 or the liquid volume (V), hence creating a cylindrical variable focus lens 10. The theoretical foundation is based on the Laplace Equation,

$$Δ P = γ ( \frac{1}{{R}_{1}} + \frac{1}{{R}_{2}} ) , \qquad ( 1 )$$

where ΔP is pressure difference between the inside and outside of bridge 12; γ is the interfacial tension between fluid phases; R₁ and R₂ are the first and second principle radii of curvature for the interface bridge 12. The principle radius of curvature R₁ or R₂ is positive when interface 12 is bent outwards (convex) and negative when interface 12 is bent inwards (concave).

The principle curvatures at point a in the mid plane of bridge 12 labeled in FIGS. 1a-1c, are:

$${k}_{1}^{a} = \frac{1}{{R}_{1}^{a}} and {k}_{2}^{a} = \frac{1}{{R}_{2}^{a}} .$$

When L is substantially larger than D (for example, as illustrated in FIGS. 1a, b, and 1c), and point a is sufficiently far from the ends of bridge 12 on the narrow side, R₂^{a} tends toward infinity; hence k₂^{a} is zero; so

$${R}_{1}^{a} = \frac{γ}{Δ P} .$$

Since ΔP is constant over the interface, the front interface (sufficiently far away from the ends of bridge 12) should have the same values of

$${k}_{1}^{a} ( \frac{Δ P}{γ} )$$

and k₂^{a}(0). Thus, the mid portion of the front interface is cylindrical. For a liquid lens 10 created by a specific liquid, its focal length is mainly governed by k₁^{a}. The shape of a liquid bridge (k₁^{a}) with two pinned contact lines is governed by H and V and, in certain cases the wettability, of the bridge 12. Therefore, the focal length of bridge lens 10 can be manipulated using at least one of H and V and wettability.

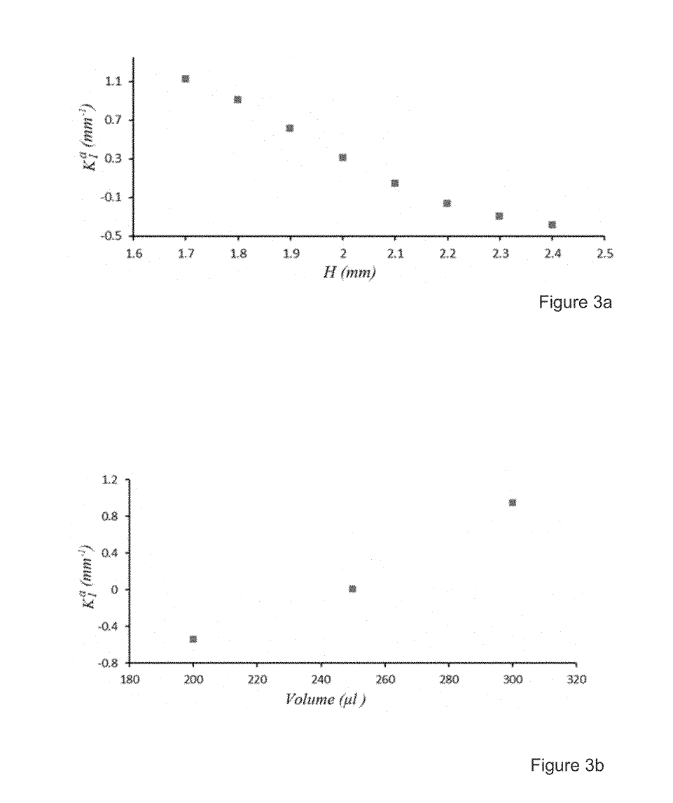

Cylindrical liquid lens 10 is then validated using the commercially available OpticStudio® and LensMechanix® software programs, from Zemax, LLC, Kirkland, Wash., U.S.A., which are commonly used to design and analyze optical systems. However, other suitable application software programs may be used for designing and analyzing cylindrical liquid lens 10. A virtual lens 10′ based on the bridge geometries from SE is then built in Zemax. By varying V and H, the interface curvature as well as the focal length of virtual lens 10 were found to change significantly with the change of V and H. FIG. 3a is a graph showing the simulated interface curvature at the mid-plane along the length of bridge 12 as the function of a 250 μl bridge 12 between opposed surfaces 14, 16 with L=30 mm and D=4 mm as function of H. FIG. 3b is a graph showing the simulated interface curvature of three different volumes (200 μl, 250 μl, and 300 μl) for bridge 12 between opposed surfaces 14, 16 with L=30 mm, D=4 mm, and H=2 mm. As shown in FIGS. 3a and 3b, there are significant changes of curvature (K₁^{a}) with the varying of both H and V.

Empirical results demonstrating how the shape of a cylindrical lens as well as the working distance of the cylindrical lens can be manipulated by varying H and V of the bridge will now be described as an example. Use of wettability as a parameter to affect the said change is also possible. The functioning of the lens is also demonstrated by comparing the profile of a circular laser beam after passing the bridge measured in a simulated environment with that of physical experiments. It should be understood that the following empirical results are provided for the purposes of explanation, and not limitation, of the present invention.

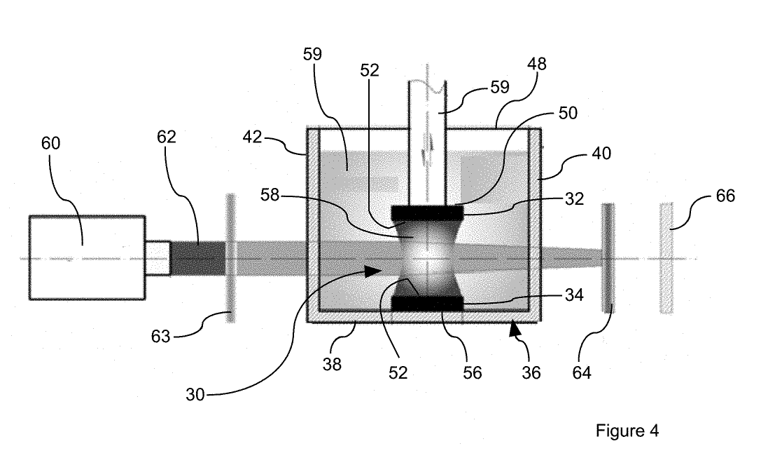

Now referring to FIG. 4, there is shown an exemplary experimental setup used for creating a cylindrical liquid lens 30, modelled after simulated lens 10. Two rectangular aluminum substrates 32, 34 are positioned in a transparent cuboid optical glass container 36 with bottom wall 38 and side walls 40, 42, 44, 46 projecting therefrom, with opening 48. Generally, bottom wall 38 and side walls 40, 42, 44 (not shown), 46 (not shown) are dimensioned to have the same wall thickness, such as 2 mm. Aluminum substrate 32 comprises top surface 50 and bottom surface 52, while aluminum substrate 34 comprises top surface 54 and bottom surface 56. Fluid bridge 58 having a reflective index of 1.33 was formed between. Aluminum substrate 34 is positioned at the bottom of container 36 such that bottom surface 56 abuts bottom wall 38 of container 36. Disposed above bottom aluminum substrate 34 is top aluminum substrate 32, in parallel, such that bottom surface 52 of top aluminum substrate 32 faces top surface 54 of bottom aluminum substrate 34. Top surface 50 of top aluminum substrate 32 is associated with driver 59 coupled to a mechanical or electrical actuating means (not shown) to predictably and accurately vary the separation distance between top aluminum substrate 32 and bottom aluminum substrate 34. In case of electrical actuation, the electrical stresses are used as mean to affect change for the shape of the fluids' interface. Accordingly, fluid bridge 58 formed between top aluminum substrate 32 and bottom aluminum substrate 34 can be compressed or stretched varying height (H). As an example, a commercially-available motion controller system from Newport Corporation, Franklin, Mass., U.S.A., model no. XPS-C6, in combination with and the ILS100CC DC servo linear stage may be used to vary the height (H), however, any other systems and/or combinations may also be used.

Generally, a stable liquid bridge 58 exists within a certain range of H with a contact line pinned on the surface edges of substrates 32, 34. As such, there are two theoretical limits for H when compressing and stretching the bridge 52 to change the interface curvature. It should be understood that changing the interface curvature also changes the focal distance and the working distance, where the working distance is defined as the distance between a focal point and the glass container 36. When the bridge 58 is compressed substantially (i.e., when H is made substantially short), bridge 58 can burst on the lengthwise (L) edge, due to a large angle φ defined as the angle between the bridge profile cross section (when bridge 58 is viewed from a side view) and a horizontal plane of the surface supporting the bridge, as labeled in FIGS. 1a, 1b and 1c. In one exemplary empirical setup, the compression of liquid bridge 58 is stopped when φ increased to 130°. The value of H at this compression level is denoted Hₘᵢₙ. The stretching of bridge 58 is stopped at the value of H where a shrinking of the contact line on the narrow edge of the liquid bridge 58 is observed, in order to ensure the pinning of the contact line. The value of H at this point is denoted Hₘₐₓ. It should be understood that particular constraining values for H and φ described in the examples herein should not be considered as limitation for all embodiments of a liquid lens 30, since the values of Hₘₐₓ and Hₘᵢₙ for each specific system (given different liquids, solid surfaces, and surface edge conditions) will vary and can be determined either from experiments or numerical simulations (e.g., using SE). In case of electrical actuation or manipulation of wettability there may not be a need to change H as electrical stresses on the interface can be the primary mean of affecting the interface curvature, hence the change of focal distance.

Once a water bridge 58 is formed, glass container 36 is filled with a surrounding liquid 59, such as silicone oil having a reflective index of 1.397, and a density of 0.935 g/ml, to minimize effects of gravity, and thereby facilitate the water of liquid lens 30 to form a cylindrical shape. With the bond number of this system (Bo=ΔρgH/γ, where Δρ is the difference between the two liquids, water and silicone oil, and g is the gravitational acceleration) being between 10⁻¹ and 10^{-3,} the effects of gravity are negligible. In order to experimentally investigate the performance of the system, a helium-neon (HeNe) laser source 60 is placed 110 mm away from glass container 36. Beam 62 of laser source 60 comprises a diameter, determined at points having an intensity 1/e² times the beam's maximum intensity where e is Euler's number, is determined to be 0.48 mm and the beam divergence is determined to be 1.7 mrad. A suitable filter 63, such as neutral density filter is place in the path of laser beam 62. CCD camera 64 (Camera I), such as A312f from Basler AG, Ahrensburg, Germany, size of pixel 8.3 μm) is placed at a first point (P1) 8.7 mm or a second point (P2) 17.6 mm away from the opposite end of the glass container 36. Another camera 66 (Camera II) such as DR1-D1312 (IE)-200-G2-8 from Photon Focus, Bern, Switzerland) is placed parallel to the short edge of the liquid bridge surfaces to image the profile (side view) of liquid bridge 58 in order to measure the values of k₁^{a} and w at different H. During the experiments, as H was varied, the position of laser source 60 is adjusted to ensure beam 62 passes through the mid-plane of liquid bridge 58.

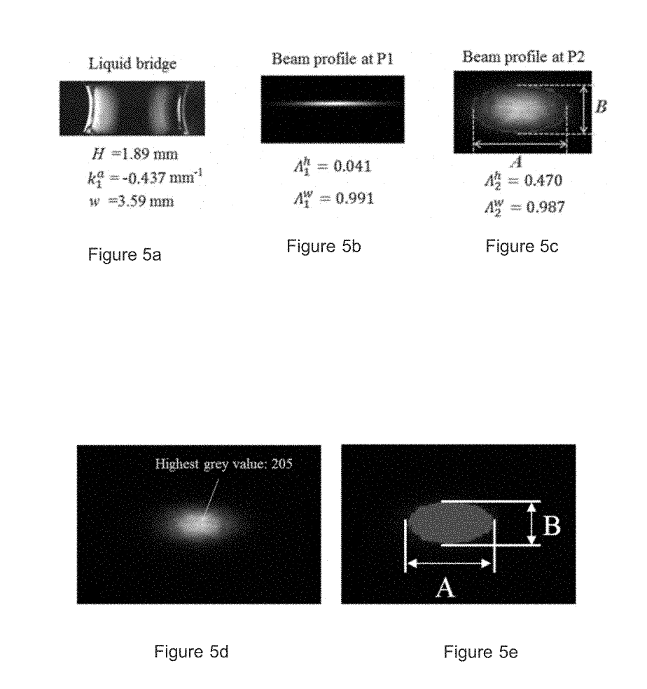

In a set of empirical trials, the cylindrical liquid lens 30 was comprises a water volume of 160 μl and H=1.89 mm. FIG. 5a depicts a side view image of liquid bridge 58, while FIG. 5b depicts a cross-sectional image of laser beam 62 passing through the liquid bridge 58 taken at position P1 and FIG. 5c depicts a cross-sectional image of laser beam 62 passing through liquid bridge 58 taken at position P2 (right image). In FIG. 5c, a dotted oval outline shows pixels having a threshold value determined to identify the laser beam profile.

To obtain the cross-sectional images of the laser beam at positions P1 and P2 in FIGS. 5a-c, different exposure times were applied to ensure the image from camera 64 or 66 was not over exposed (i.e., that the highest 8-bit gray value, Yₘₐₓ, of the image pixels obtained from the camera 64 or 66 was smaller than 255). The cross-sectional profile of laser beam 62 was identified using the threshold pixels having gray values of

$$\frac{{Y}_{max}}{{e}^{2}} .$$

FIG. 5d shows a cross-sectional image of laser beam 62 at position P2 after passing through liquid bridge 58, and FIG. 5e shows the corresponding identified laser beam profile. The highest gray value in FIG. 5d was found to be 205. Given this value, the threshold value for identifying the beam boundary is calculated to be 27, and the cross-sectional profile of laser beam 62 was determined accordingly to be the area shown FIG. 5e. The width (A) and height (B) of beam 62 labeled in FIG. 5e were measured based on the horizontal and vertical extents, respectively, of the determined cross-sectional laser beam profile.

To evaluate the performance of cylindrical lens 30 used to obtain the images of FIGS. 5a-c, the width (A) and height (B) of the laser beam profiles after passing the liquid bridge 58 were measured at both positions P1 and P2. Two parameters, the height varying ratio (Λ^{h}=B/d, where d is the diameter of the profile without liquid lens 30 in the optical path, measured as 0.598 mm at P1 and 0.605 mm at P2) and width varying ratio (Λ^{w}=A/d) were defined and calculated to quantitatively describe the beam profile change, in this example. From FIGS. 5a-c, l it can be seen that the values of Λ^{w} at position P1 (0.991) and position P2 (0.987) are both close to 1, indicating little to no change of beam 62 in horizontal direction, which confirms that k₂^{a} is very close to zero in the mid part of the front interface, indicating that a substantially cylindrical lens 30 has been created. The value of K₁^{a} was determined measured to be −0.437 mm⁻¹, indicating that bridge 58 has a concave shape. In this example, since the reflective index of the water is smaller than that of silicone oil, bridge 58 serves as a converging lens 30. The circular shape laser beam profile was focused into a thin line at position P1, corresponding to a very small Λ^{h} of 0.041. As expected, beyond the focal point, laser beam 62 starts to diverge. Accordingly, Λ^{h} at position P2 was found to be 0.470.

Based on the empirical results shown in FIGS. 5a-c, it is demonstrated that liquid bridge 58 can serve as a cylindrical lens 58, i.e., a lens which varies the laser beam profile substantially only in one dimension.

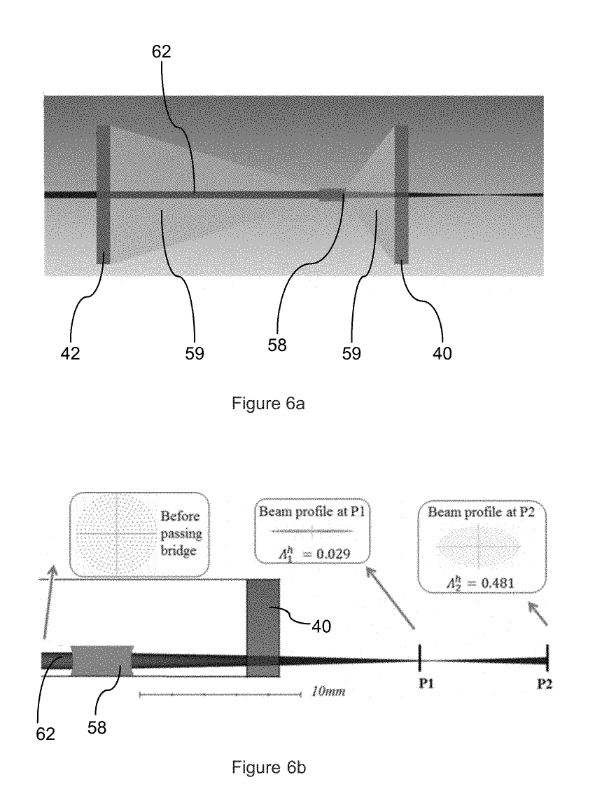

To verify the quality of the empirically tested liquid lens 30 of FIGS. 4, 5a-5e, a comparison of its performance and an ideal cylindrical lens with the same specifications was performed. Using the specifications of the empirically tested liquid lens system, and the corresponding ideal cylindrical lens simulation was created using the Zemax software. FIG. 6a is a schematic illustration of the cylindrical lens 10 simulated in Zemax. The simulated lens 10 depicted was specified to be a 160 μl liquid lens with H=1.89 mm. The reflective index of glass, silicone oil and water were set to be 1.44, 1.397, and 1.33, respectively. The two side interfaces between the water bridge and the silicone oil were set as toroidal type with a height of 1.89 mm. The radius of the two side interfaces were set to be −2.29 mm and 2.29 mm, respectively, based on the corresponding experimental data described above. The distance between these two interfaces was set to be 3.59 mm, corresponding to w of the liquid bridge measured experimentally. The value of Λ^{w} were obtained by measuring the shape of a light ray (entrance pupil diameter: 0.5 mm, wavelengths 0.633 μm) captured at position P1 and position P2 after passing this ideal cylindrical lens.

FIG. 6b is an illustration of simulation results from Zemax for the ideal lens model shown in FIG. 6a. Good agreements between the simulation and experimental measurement can be seen. The working distance of this lens system was found to be 9.84 mm in the simulation, which is close to the value of P1 determined experimentally (8.7 mm). The value of Λ^{h} at both P1 (0.029) and P2 (0.481) calculated from simulation are also close to the values measured experimentally (0.041 and 0.470 at P1 and P2, respectively).

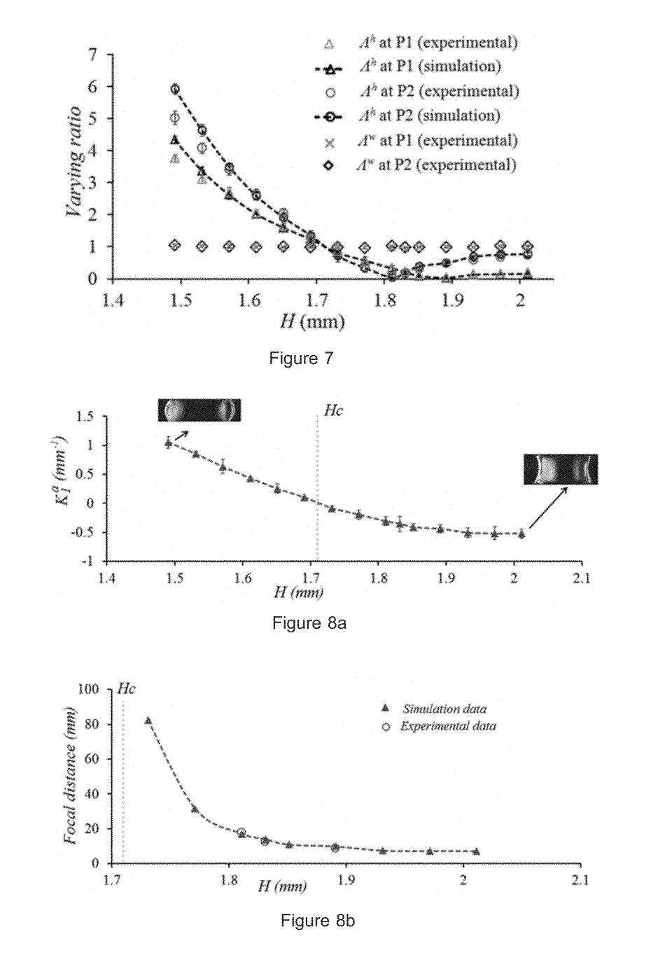

FIG. 7 is a graph showing values of Λ^{h} (both experimental and simulation) and Λ^{w} (experimental) at position P1 and position P2 as a function of H for the empirical testing setup of FIG. 4 and the simulation of FIG. 6a described above. From FIG. 7 it can be seen that there is generally good agreement, with minor differences, between the experimental and simulation results. The minor differences could be caused by the measurement errors of the interface curvature and other non-ideal aspects of the experimental setup, for example divergence of the HeNe laser. It can also be seen that the values of Λ^{w} measured experimentally always stay close to 1, regardless of the change of H. Therefore, it is again demonstrated that the liquid bridge configuration tested can be used as a cylindrical lens.

In some embodiments, the shape as well as the focal length of a liquid lens is manipulated by varying the height of the bridge (H). FIG. 8a is a graph of the principal curvature (k₁^{a}) of a 160 μl liquid bridge as a function of the height (H) of the liquid bridge, measured experimentally using the apparatus of FIG. 4. It can be seen that k₁^{a} decreases monotonically from 1.03 mm (a convex bridge, as depicted in the left insert) to −0.52 mm⁻¹ (a concave bridge, as depicted in the right insert) when H increased from Hₘᵢₙ (1.49 mm) to Hₘₐₓ (2.01 mm). Accordingly, such a liquid bridge can be used as either a converging lens or diverging lens by only changing its height. Theoretically, there exists a critical H (H_{c}, approximately 1.71 mm for this case) where the front interface becomes completely flat (i.e., both k₁^{a} and k₂^{a} become zero). Therefore, a diverging lens can be obtained when H is smaller than H_{c}, or alternatively, a converging can be obtained when H is stretched to be larger than H_{c}.

With the changing of the curvature, the working distance of a liquid lens can also be changed significantly. FIG. 8b is a graph of the working distance of a 160 μl liquid bridge as a function of the height (H) of the liquid bridge obtained from both the experimental apparatus of FIG. 4 and the Zemax simulation of FIG. 6a. Theoretically, the working distance is infinite when the bridge is at H_{c}. With the increase of H, the working distance decreases monotonically due to the decrease of k₁^{a}. When H is increased to Hₘₐₓ, k₁^{a} reaches its smallest value. At this point, the shortest working distance (7.51 mm) for the example apparatus can be achieved.

It should also be understood that the working distance of the lens can also be affected by the thickness of the bridge (w). However, the variation of w for some embodiments described herein is small, and therefore the effect of w on the working distance is negligible compared to k₁^{a}. To test the effect of bridge thickness on lens focal distance, Zemax simulations were performed. For a 160 μl bridge at H=1.77 mm, k₁^{a} and w were found to be −0.193 mm⁻¹ and 3.85 mm, respectively. Using these two parameters in Zemax, the focal distance of this bridge was found to be 32.7 mm. Measured experimentally using the apparatus of FIG. 4, the thickness of the 160 μl bridge only varies between 4.73 mm and 3.43 mm. To demonstrate the effect of w on the focal distance, two more Zemax simulations were performed. In these two simulations, the bridge curvatures were still set to be −0.193 mm⁻¹, but w was set to be 3.43 mm (minimal w) and 4.73 mm (maximal w), respectively. The focal distance of these two systems were found to be 32.67 mm and 32.88 mm, respectively which are both very close to the focal distance of the bridge with w=3.85 mm. As such, it is demonstrated that the bridge thickness does not significantly affect the focal distance in some embodiments.

In some embodiments, varying the fluid volume can also be used to manipulate the performance of the liquid lens. In some embodiments, the fluid volume is manipulated while maintaining a fixed H. In other embodiments, the fluid volume is manipulated while also adjusting H. In other embodiments, for example, electrical stresses or wettability manipulation can be used to achieve the same said effect.

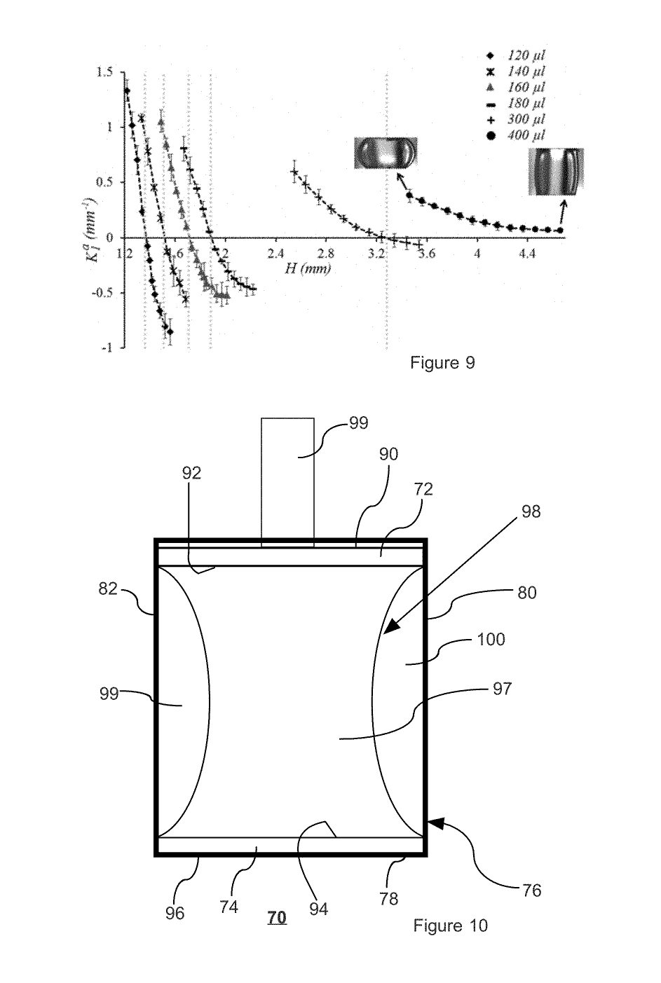

FIG. 9 is a graph of the principal curvature (k₁^{a}), for liquid bridges measured using variations of the apparatus of FIG. 4, with six different volumes (120 μl, 140 μl, 160 μl, 180 μl, 300 μl, and 400 μl)) as a function of the height (H) of each liquid bridge. It can be seen that the change of V does not affect the dependence of k₁^{a} on H. That is, k₁^{a} decreases monotonically with the increase of H. However, with the increase of volume, both Hₘᵢₙ and Hₘₐₓ for the bridge become larger, indicating that a larger/higher stable liquid lens can be created with the same surfaces when V is increased. It can also be seen that with the increase of liquid volume, the range of k₁^{a} (i.e., the maximal and minimal k₁^{a}) that can be achieved by the lens decreases. Since k₁^{a} is the main parameter governing the working distance, the covered range of the lens working distance changes with the change of the volume as well. For example, compared with the 160 μl bridge, the 120 μl bridge has a smaller minimum achievable k₁^{a} (−0.828 mm⁻¹), which allows it to achieve a 2.11 mm as the minimal working distance (smaller than the one for the 160 μl bridge, 7.51 mm). Therefore, based on the results shown in FIG. 9, it is demonstrated that a small volume is suitable for creating a liquid cylindrical lens with a substantially short height and a substantially large range of the working distances, while a large volume is suitable for creating a liquid cylindrical lens with substantially larger height but substantially smaller range of the working distances.

When the liquid volume was increased to 400 μl, k₁^{a} of the bridge is always positive and no H_{c} can be found in this example. Therefore, in some embodiments the liquid bridge can be configured to always serve as a diverging lens, if one does not change the used liquid.

For embodiments with a liquid bridge at H_{c}, the front interface is substantially flat. Therefore, the width of the bridge cross section (w) is substantially the same as the width of surfaces; hence w=D (2). Second, ΔP should be zero all over the interface. Based on the Laplace EQ, it is possible that 0=ΔP_{b}=γ(k₁^{b}+k₂^{b}) (3), where b is middle point of the interface between narrow edges (see FIGS. 1a to 1c). The value of k₁^{b} is mainly affected by the contact angle on the narrow edge (θ), as well as the distance between the two surfaces of the substrates. The value of k₂^{b} is mainly affected by the width of the bridge (w). Assuming that

$$\begin{matrix}{k}_{1}^{b} = \frac{- 2 cos θ}{{H}_{c}} and & ( 4 ) \\ {k}_{2}^{b} = \frac{2}{w} , & ( 5 )\end{matrix}$$

and substituting equation (2) (4) and (5) into equation (3), it is determined that H_{c}−cos θ×D (6). Since the front interface is flat, H_{c} can be written as

$${H}_{c} = \frac{V + {V}^{′}}{LD} , \qquad ( 7 )$$

where V′=H_{c}LD−V. Combining EQ. (6) to EQ. (7), then V+V′=LD²×cos θ<=LD² (8). Since

$$cos θ = \frac{{H}_{c}}{D} > 0 ,$$

θ is smaller than 90°. Therefore, H_{c}LD−V>0; hence V′ should be a positive value. The equation (8) eventually becomes V<LD² (9). Based on equation (9), H_{c} exists when the volume of the bridge is less than LD². For this system, L=25 mm, D=4 mm, indicating that the equation (9) is not valid when V=400 μl; hence the bridge is always convex. Therefore, a liquid volume larger than LD² is suitable for creating embodiments with a large lens whose shape is expected to be always convex.

As described above, a cylindrical lens can be created by forming a liquid bridge between two narrow surfaces. The curvature of the bridge interfaces (k₁^{a}) and hence the working distance of the lens can be manipulated by varying either or both of H and V of the liquid bridge in some embodiments. With the increase of H, the curvature of the bridge interface which governs the lens working distance decreases monotonically. For a liquid bridge, a critical H_{c} where k₁^{a} is zero can exist in some embodiments. In embodiments when H is larger than H_{c}, k₁^{a} is negative. In embodiments where H is smaller than H_{c}, k₁^{a} is positive, the liquid bridge volume can also affect the performance of the cylindrical liquid lens. A small volume is, for example, suitable for embodiments to create a cylindrical liquid lens with small height but large range of the working distance. A large volume is, for example, suitable to create a cylindrical liquid lens with larger height but smaller range of the working distance. It is also shown both theoretically and experimentally that in embodiments where the liquid volume is larger than LD², only a convex shape bridge is created.

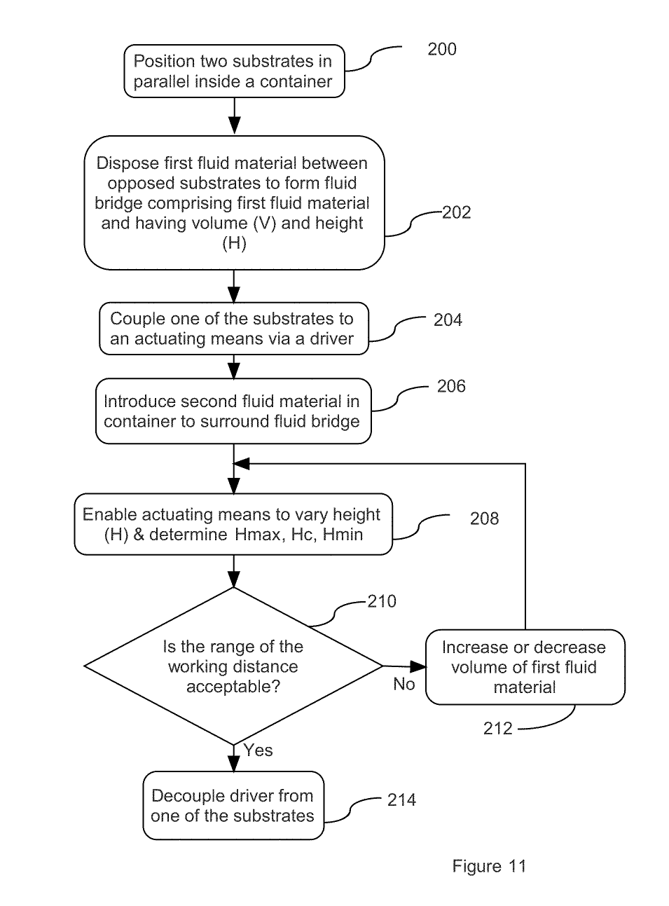

In another implementation, a variable focal length lens 70, as shown in FIG. 10, is fabricated following similar process steps pertaining to the exemplary experimental setup, as described above. Referring to FIG. 11, there is shown a high level flow diagram illustrating exemplary process steps for manufacturing tunable focal cylindrical liquid lens 70. In step 200, two substrates 72, 74 are positioned in a transparent container 76 with bottom wall 78 and side walls 80, 82, 84 (not shown), 86 (not shown) projecting therefrom, with opening 88. Substrates 72, 74 are disposed parallel to each other. Generally, bottom wall 78 and side walls 80, 82, 84, 86 are dimensioned to have the same thickness. Substrate 72 comprises top surface 90 and bottom surface 92, while substrate 74 comprises top surface 94 and bottom surface 96. Next, in step 202, a first fluid material 97 of a predetermined volume (V) is disposed between substrates 72, 74 to form fluid bridge 98 having a height (H), and a curvature at the interfaces (k₁^{a}) between fluid bridge 98 and substrates 72, 74, such that fluid bridge 98 is substantially cylindrical. In step 204, top surface 90 of top substrate 72 comprises driver 99 coupled to an actuating means (not shown) to vary the separation distance between top substrate 72 and bottom substrate 74. Actuating means may be manual, mechanical, electromechanical or electrical. Accordingly, fluid bridge 98 formed between top substrate 72 and bottom substrate 74 can be compressed or stretched varying height (H) in this embodiment. With the fluid bridge 98 formed, in step 206, transparent container 76 is filled with second fluid material 100, which surrounds fluid bridge 98 and facilitates formation of a cylindrically-shaped fluid bridge 98, and maintenance of that cylindrical shape. In step 208, actuating means is enabled to vary the separation distance between top substrate 72 and bottom substrate 74, and to determine Hₘₐₓ, H_{c}, and Hₘᵢₙ in this exemplary embodiment. Next, in step 201, a range of the working distance of lens 70 is determined, and when the working distance range is not within the desired thresholds then the volume of the first material may be increased or decreased (step 212) and the process goes back to step 208. However, when the working distance range is acceptable then driver 99 is decoupled from top substrate 72, in step 214, and the process ends.

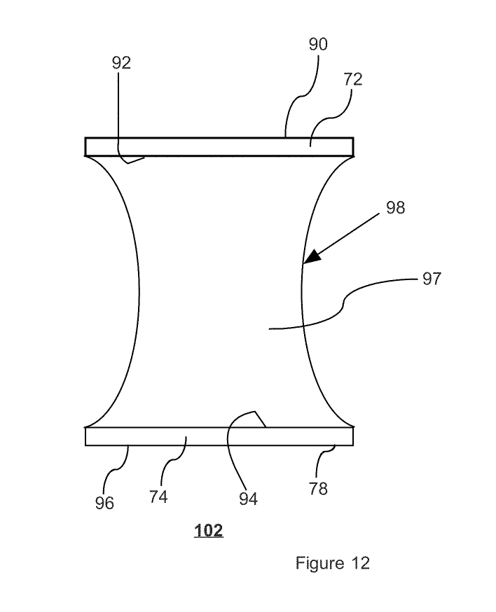

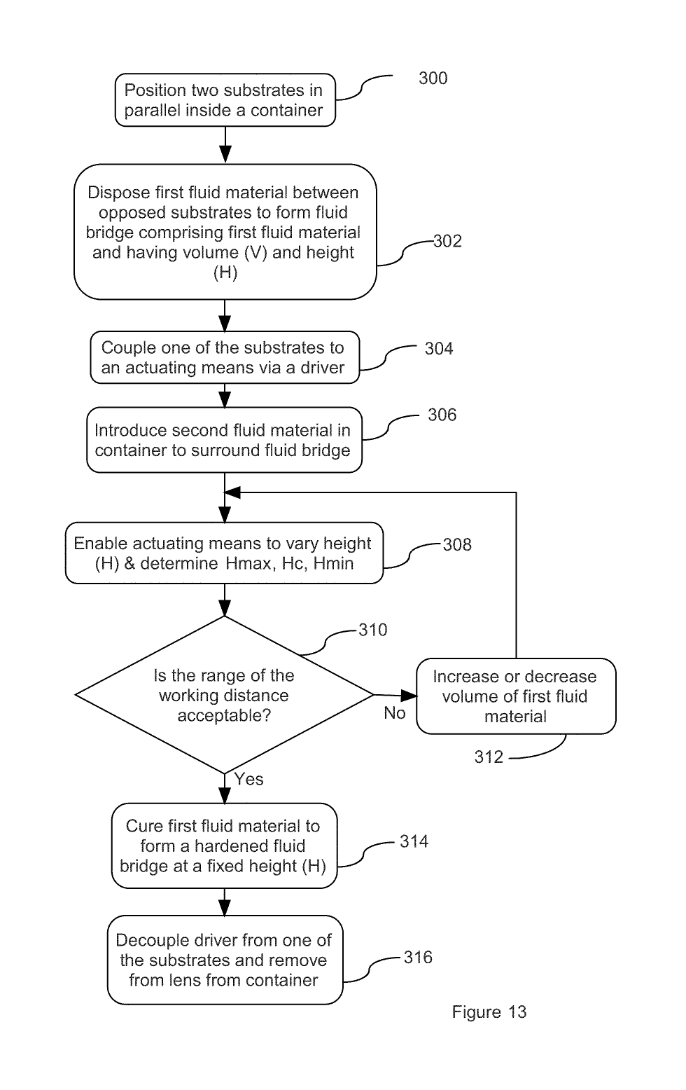

In yet another implementation, a fixed focal length lens 102, as shown in FIG. 12, is fabricated following similar process steps shown in FIG. 11, as described above. Referring to FIG. 13, there is shown a high level flow diagram illustrating exemplary process steps for fabricating a fixed focal length cylindrical liquid lens 102. In step 300, two substrates 72, 74 are positioned parallel to each other in a transparent container 76 with bottom wall 78 and side walls 80, 82, 84 (not shown), 86 (not shown) projecting therefrom, with opening 88. Substrates 72, 74 are disposed parallel to each other. Generally, bottom wall 78 and side walls 80, 82, 84, 86 are dimensioned to have the same thickness. Substrate 72 comprises top surface 90 and bottom surface 92, while substrate 74 comprises top surface 94 and bottom surface 96. Next, in step 302, a fluid material, such as a polymer liquid of a predetermined volume (V) is disposed between substrates 72, 74 to form fluid bridge 98 having a height (H), and a curvature at the interfaces (k₁^{a}) between fluid bridge 98 and substrates 72, 74, such that fluid bridge 98 is substantially cylindrical. In step 304, top surface 90 of top substrate 72 is coupled to an actuating means 98 (not shown) to vary the separation distance between top substrate 72 and bottom substrate 74. Actuating means 98 may be manual, mechanical, electromechanical or electrical. Accordingly, fluid bridge 98 formed between top substrate 72 and bottom substrate 74 can be compressed or stretched varying height (H) in accordance to the desired nature or characteristics of the resultant lens 102. With the fluid bridge 98 formed, in step 306, transparent container 76 is filled with a second fluid material 100, which surrounds fluid bridge 98 and facilitates fluid bridge 98 form and maintain a cylindrical shape.

In step 308, actuating means is enabled to vary the separation distance between top substrate 72 and bottom substrate 74, and to determine H_{max,} H_{c}, and H_{min.} Next, in step 310, a range of the working distance of lens 70 is determined, and when the working distance range is not within the desired thresholds then the volume of the first material may be increased or decreased (step 312) and the process goes back to step 308. However, when the working distance range is acceptable, then in step 314, the polymer of fluid bridge 98 is cured such that the polymer liquid hardens at a fixed height (H), while it may or may not form a bond at the interface between fluid bridge 98 and substrates 72, 74. In step 316, an actuating means 98 is decoupled from substrate 72, and fixed focal length lens 102 formed of substrates 72, 74 and fluid bridge 98 with hardened polymer is removed from transparent container. Optionally, fixed focal length lens 102 may be tested to verify desired optical properties before, or after, curing step 308.

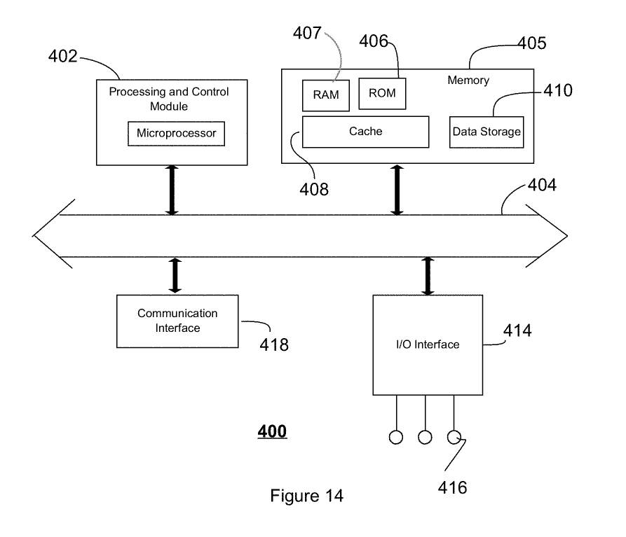

In yet another implementation, either the height (H) or the volume (V) of the liquid bridge, or both, are varied via electronic means, such as, a computing device or system 400, or microcontroller is configured to control the variation of H and/or V. As shown in FIG. 14, an exemplary computing system or general-purpose computing device 400 comprises processing unit (CPU or processor) 402 and system bus 404 that couples various system components including system memory 405 such as read only memory (ROM) 406 and random access memory (RAM) 407 to processor 402. System 400 can include a cache 408 of high speed memory connected directly with, in close proximity to, or integrated as part of processor 402. System 400 copies data from memory 405 and/or storage device 410 to cache 408 for quick access by processor 400. In this way, cache 408 provides a performance boost that avoids processor 402 delays while waiting for data. Processor 402 can include any general purpose processor and a hardware module or software module, stored in storage device 410, configured to control processor 402 as well as a special-purpose processor where software instructions are incorporated into the actual processor design. Processor 402 may essentially be a completely self-contained computing system, containing multiple cores or processors, a bus, memory controller, cache, etc., or on a group or cluster of computing devices networked together to provide greater processing capability. A multi-core processor may be symmetric or asymmetric.

In yet another implementation, a lens or lens system is fabricated to include a plurality of substrates with any two substrates separated by fluid material to form a fluid bridge. The fluid material between any of the substrates may be the same. Alternatively, the fluid material between any of the substrates may be different, such that each different fluid material is associated with a different optical property to transmit at least one portion of an electromagnetic spectrum. Accordingly, the lens or lens system may be useful as a sensor for certain wavelengths of the electromagnetic spectrum. As an example, infra-red (IR) transmitting fluid materials may be employed to create lenses for different regions of IR spectrum, or to perform spatial encoding of light using light dispersing fluids. As the magnitude of the separation, volume, curvature of the substrates, wettability of the substrates, and the electrical stress state the fluid bridge interfaces can be variable of affect the optical properties for each fluid bridge, then a customizable lens or lens system can be fabricated.

In one aspect, a hardware module that performs a particular function includes the software component stored in a non-transitory computer-readable medium in connection with the necessary hardware components, such as processor 402, bus 404, and I/O device via I/O interface 414, and so forth, to carry out the function. It should be appreciated by those skilled in the art that other types of computer readable media which can store data that are accessible by a computer, such as magnetic cassettes, hard disk, flash memory cards, digital versatile disks, cartridges, random access memories (RAM), read only memory (ROM), a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 400, input devices 416 represents any number of input mechanisms, such as a microphone for speech, a touch-sensitive screen for gesture or graphical input, keyboard, mouse, motion input, speech and so forth. Output device 22 can also be one or more of a number of output mechanisms known to those of skill in the art. In some instances, multimodal systems enable a user to provide multiple types of input to communicate with computing device 10. Communications interface 418 generally governs communications with other devices 400′ (not shown) via a communication medium (wired or wireless). There is no restriction on operating on any particular hardware arrangement and therefore the basic features here may easily be substituted for improved hardware or firmware arrangements as they are developed.

The functions of one or more processors, presented in FIG. 14, may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 400, shown in FIG. 14, can practice all or part of the recited methods, can be a part of the recited systems, and/or can operate according to instructions in the recited non-transitory computer-readable storage media. Such logical operations can be implemented as modules configured to control processor 402 to perform particular functions according to the programming of the module. Accordingly, a non-transitory computer readable medium comprising instructions for execution by a processor may be provided for controlling the variation of H and/or V. In some embodiments, the instructions for execution by a processor may be embodied in the form of a software product. The software product may be stored in a non-volatile or non-transitory storage medium, which can be, for example, a compact disc read-only memory (CD-ROM), universal serial bus (USB) flash disk, or a removable hard disk.

Although the invention has been described with reference to certain specific embodiments, various modifications thereof will be apparent to those skilled in the art without departing from the spirit and scope of the invention.

1. A variable focus lens comprising:
at least two substrates having a gap defined therebetween;
a fluid material disposed between the at least two substrates to form a fluid bridge with a fluid bridge interface, the fluid material having a predetermined volume, wherein the fluid material is in contact with each of the at least two substrates; and
wherein at least one of a magnitude of the gap, the predetermined volume, curvature of the at least two substrates, wettability of the at least two substrates, and electrical stress state oil the fluid bridge interface determines a working distance of the lens.

2. The lens of claim 1, wherein at least one of the gap, the volume, the wettability of substrates and the electrical stress state on the fluid bridge interface is variable, such that the characteristics of the lens is dependent on the magnitude of at least one of the gap, the volume, the wettability, and the electrical stress state of the fluid bridge interface.

3. The lens of claim 2, wherein a curvature of the fluid bridge interface is dependent on at least one of the variable gap, variable volume, the wettability, and the electrical stress state of the fluid bridge interface.

4. The lens of claim 2, wherein the curvature of the fluid bridge can be changed by the state of electrical stress on the fluid bridge interface, such that a focal length of the lens can be changed while the magnitude of the gap or the volume remains unchanged.

5. The lens of claim 2, wherein the curvature of the fluid bridge can be changed by manipulating the wettability of the substrates, such that a focal length of the lens can be changed while the magnitude of the gap, the volume, and the electrical stress remain unchanged.

6. The lens of claim 1, wherein at least one fluid bridge formed between a plurality of the substrates comprises a different fluid material with a different optical property to transmit at least one portion of an electromagnetic spectrum.

7. The lens of claim 6, wherein the lens functions as a sensor for the least one portion of the electromagnetic spectrum.

8. The lens of claim 1, wherein each of the fluid bridge formed between a plurality the substrates comprises the same fluid material to transmit at least one portion of an electromagnetic spectrum.

9. The lens of claim 2, wherein the gap between the substrates is varied by at least one of a manual, mechanical, electromechanical and electrical means.

10. The lens of claim 2, wherein the lens is at least one of a converging lens and a diverging lens.

11. A method for fabricating a variable focus lens, the method comprising steps of:
separating a first substrate and a second substrate by a distance (H),
disposing a fluid material between the first substrate and the second substrate to form a fluid bridge with a fluid bridge interface, wherein the fluid material is in contact with the first substrate and the second substrate; the fluid bridge having a predetermined volume (V) of the fluid material; and wherein at least one of the first substrate and the second substrate is moveable to change the magnitude of the distance (H);
surrounding said fluid bridge with a second fluid material other than air; and
whereby the magnitude of the distance (H) and the magnitude of the volume (V) determines at least one of the properties of the variable focus lens.

12. The method of claim 11, wherein at least one of a curvature of the substrates, wettability of the substrates, and electrical stress state on the fluid bridge interface determines said at least one of the properties of the variable focus lens.

13. The method of claim 11, wherein at least one of the volume (V), the wettability of the substrates and the electrical stress state on the fluid bridge interface is variable, such that the characteristics of the lens is dependent on the magnitude of at least one of the distance (H), the volume (V), the wettability of the substrates and the electrical stress state on the fluid bridge interface.

14. The method of claim 11, herein principle curvatures at point a in a mid-plane of the fluid bridge are defined as:
$${k}_{1}^{a} = \frac{1}{{R}_{1}^{a}} and {k}_{2}^{a} = \frac{1}{{R}_{2}^{a}} ,$$
such that a focal length variable focus lens is governed by k₁^{a}, and the shape of a liquid bridge (k₁^{a}) with two pinned contact lines at the first substrate and the second substrate is governed by H and V of the fluid bridge, such that the focal length can be manipulated using at least one of H and V.

15. The method of claim 14, wherein there exists a critical H (H_{c}) where the front interface becomes completely flat and k₁^{a} and k₂^{a} are both zero, and when H is smaller than H_{c} a diverging lens is formed.

16. The method of claim 14, wherein there exists a critical H (H_{c}) where a front interface becomes completely flat and k₁^{a} and k₂^{a} are both zero, and when H is greater than H_{c} a converging lens is formed.

17. The method of claim 14, wherein the fluid material is curable to form a fixed focal length lens.

18. The method of claim 13, further comprising separating at least one other substrate from the second substrate separated by the distance (H),
disposing the fluid material between the at least one other substrate and the second substrate to form another fluid bridge with another fluid bridge interface, the another fluid bridge having a predetermined volume (V) of the fluid material.

19. The method of claim 18, wherein the another fluid bridge comprises a different fluid material.

20. A tunable lens system comprising:
a first substrate and a second substrate separated by a variable gap;
a fluid bridge disposed between the variable gap with a fluid bridge interface, the fluid bridge comprising a variable volume, wherein the fluid bridge is in contact with the first substrate and the second substrate; and
a controller coupled to at least one of the first substrate and the second substrate to change the magnitude of the variable gap; and
wherein a variable working distance of the lens is dependent at least one of the variable gap, the variable volume, curvature of the at least two substrates, wettability of the substrates, and electrical stress state on the fluid bridge interface.

21. The system of claim 20, wherein the controller comprises one or more processors; memory; one or more programs stored in the memory and configured to be executed by the one or more processors to move at least one of the first substrate and the second substrate to change the magnitude of the variable gap and change the variable volume.

22. The system of claim 21, wherein the controller is removably coupled to at least one of the substrates.
